(19) United States
(12) Patent Application Publication
(10) Pub. No.: US 2024/0144900 A1
(43) Pub. Date: May 2, 2024

(54) System and method for controlling sound synthesis instrument using tactile surface

(71) Applicants: Cameron Warner Jones, D'Escousse (CA); Craig Philips, Louisdale (CA)

(72) Inventors: Cameron Warner Jones, D'Escousse (CA); Craig Philips, Louisdale (CA)

(21) Appl. No.: 18/496,334

(22) Filed: Oct. 27, 2023

Related U.S. Application Data
(60) Provisional application No. 63/381,236, filed on Oct. 27, 2022.

(51) Int. Cl. G10H 1/00; G10H 1/34

(52) U.S. Cl. CPC G10H 1/0008; G10H 1/34; G10H 2220/161; G10H 2220/201; G10H 2220/311

(57) ABSTRACT

The present invention provides a tactile surface for partial timbre sound synthesis instrument, the tactile surface comprising a swiper and a selector pads. The swiper and selector pads comprise a top silicone layer coated with polyepoxide that extends down through casework to a printed circuit board with capacitive touch sensor pads.

### CROSS-REFERENCE TO RELATED APPLICATIONS

The present patent application claims the benefits of priority of the U.S. Provisional Patent Application No. 63/381,236, entitled “System and method for controlling sound synthesis instrument using tactile surface”, and filed at the United States Patent and Trademark Office on Oct. 27, 2022, the content of which is incorporated herein by reference.

### FIELD OF THE INVENTION

The present invention generally relates to the field of electronic musical instruments and in particular to electronic musical instruments and methods of using the same called upon to produce complex sounds which are generated by a partial timbre sound synthesis instrument. More particularly, the present invention relates to system and methods of improving the control of the sounds generated by the instrument.

### BACKGROUND OF THE INVENTION

Partial timbre sound synthesis instruments, also referred to as synthesizers, may emulate natural or traditional musical sounds, in contrast to sounds of pure functions commonly labeled as electronic sound. A partial timbre sound synthesis method and instrument is described in detail in U.S. Pat. No. 4,554,855 granted Nov. 26, 1985. All descriptions and figures from the U.S. Pat. No. 4,554,855 are incorporated herein by reference, as they directly relate to the utility and operation of the improved instrument described herein.

Electronic musical instruments are typically controlled by a diverse collection of knobs, buttons, sliders, faders, switches, encoders and other mechanical, electrical and/or optical devices that provide means for the musician to operate the device to achieve the desired auditory outcome.

The knobs, buttons, sliders, faders, switches and encoders incorporated in existing electronic musical instruments all suffer from a variety of drawbacks which impair the ability of a musician to precisely and effectively control the sound output of a partial timbre sound synthesis instrument. For example, knobs and faders typically have limited angles or ranges of motion. Also, prior art electronic musical instruments may further comprise mechanical defects such as internal friction and hysteresis. Buttons and switches can be noisy, can have a cumbersome range of motion, sharp edges or other physical attributes that impair their use in a musical instrument.

There is thus a need for an improved electronic musical instrument incorporating a novel tactile surface providing means for a user to control the sound output of the instrument that is more convenient and accurate than means provided in prior art.

### SUMMARY OF THE INVENTION

The shortcomings of the prior art are generally mitigated by using capacitive remote-sensing electronic circuits to detect the finger motion of the operating musician. A novel button shape and material type is presented that both provides tactile feedback to the musician and mitigates the shortcomings of traditional knobs, buttons, sliders, faders, switches and encoders. The tactile feedback provided to the musician includes elements of size, shape and friction.

The main aspects of this invention are 1) the size, shape and spacing of the tactile touch areas; 2) the friction of the touch areas that provide a very desirable “feel” to the tactile surface; and 3) functionality of the touch areas as they specifically relate to the implement of a partial timbre sound synthesis instrument.

In one aspect of the invention, a control panel of an electronic musical instrument comprises a swiping area. The control panel may further comprise a layer conducting capacitance from digits of a user or from any other body part of a user. The layer may be embodied as a silicone membrane or may be made of any other solid material that conducts the capacitance from a finger or body part of a user from a top layer, typically the top surface of the coating, to the printed circuit board. The layer generally extends or protrude from the printed surface board through apertures in a casework layer.

In some aspects of the invention, the casework layer may be embodied as a sheet metal. The sheet metal may have a thickness of about 1.6256 mm. The printed circuit board is positioned underneath the other layers. Understandably, the printed circuit board generally comprises capacitive touch sensor pads. The layers of the swiper thus provide tactile feedback to the musician aiming at facilitating and improving the musical's ability of one to precisely and accurately control the character of the sound that is generated by the instrument. The printed circuit board, or other capacitive sense circuitry, generally comprises a means for the instrument to record and measure the operator's input. The swiping area may further comprise a silicone membrane or other solid material that conducts the capacitance from a user's digits from the top surface of the coating to the printed circuit board. This layer extends or protrudes from the printed surface board through apertures in the casework. In this embodiment, the casework is manufactured from sheet metal of 1.6256 mm thickness.

The printed circuit board, or other method used to sense and capture capacitance data is underneath the other layers. The printed circuit board generally comprises capacitive touch sensor pads. The layers of the swiper thus provide tactile feedback to the musician aiming at facilitating and improving the musical's ability of one to precisely and accurately control the character of the sound that is generated by the instrument. The printed circuit board, or other capacitive sense circuitry, generally comprises a means for the instrument to record and measure the operator's input, such as but not limited to a swiping area.

The swiping area is generally made of a continuous strip of polyepoxide-coated silicone, which is both durable and smooth. The capacitive touch sensors measure the capacitance between small conductive pads under the swiping area and the digit of the operating musician. In a typical embodiment there would be 12 discrete conductive pads under the swiping area.

Electronic means transfer the capacitance measurements to a computer or computerized device. The computer or computerized device compares the changes in capacitance of each conductive pad over time and uses an interpolation method to precisely measure the position of the finger relative to each pad, creating a data model of the position and direction of movement and speed of movement of one or more digits on the surface of the swiper. The system is further configured to ignore background noise.

In some aspect of the invention, the capacitive touch sensor apparatus provides 256 discrete capacitance measurements to the computer every millisecond. The computer averages 256 measurements to mitigate the effects of background noise. The computer records the average reading for each millisecond for each measurement pad. By observing the change in capacitance of each pad over a time period of several hundred milliseconds the computer can detect swiping and tapping motions of the operating musician's digits. The parameter values the operating musician wishes to alter may be increased or decreased as a function of the length of the swipe. In events of tapping, the parameter value can be increased or decreased by a fixed nudge amount. In another example, if one finger or thumb is held on the unit while a second digit swipes, the computer engages fine mode and the parameter can be adjusted by smaller increments.

In yet another aspect of the invention, the system comprises a selecting area. The selecting area is typically an arrangement of twelve shallow polyepoxide-coated silicone touch pads arranged in a rectilinear castellated fashion, enabling single swipes of a finger across multiple buttons in one single movement. The system further comprises a computer or computerized system in data communication with the selecting area. The computer is generally configured to receive the real-time data signal from the capacitive touch sensors. The computer is further configured to build a model using the data signals received when the sensors are being touched. Taps on singular pads are sent to the user interface to toggle button states on or off. Swipes across several pads are interpreted to toggle several button states at once, in real-time.

In another aspect of the invention, a partial timbre sound synthesis instrument is provided. The partial timbre sound synthesis instrument comprises a structural layer, a tactile feedback interface and a processing device in data communication with the tactile feedback interface, the processing device being configured to build a model from the data signals received from the tactile feedback interface.

The tactile feedback interface may comprise at least one swiper or at least one selector pad.

The tactile feedback interface may comprise a touch conductive layer and an interface layer over the conductive layer, wherein the structural layer comprises apertures allowing passage of one or more portions of the interface layer. The touch conductive layer may comprise a printed circuit board comprising a capacitive sensor. The printed circuit board may further comprise a musical instrument recorder and input measurement mechanism.

The interface layer may be made of a non-conductive and resilient material, such as silicone. The silicone layer may be coated, such as with polyepoxide. The coating may be made of material providing a modicum of friction, the coating allowing fast swiping motions from a user while receiving tactile feedback. The coating may be made of material providing protection against ultraviolet degradation and other forms of degradation.

The interface layer may form a thin convex layer. The interface layer may extend or protrude from the apertures of the structural layer.

The structural layer may be made of a rigid material.

The interface layer may be made of a single silicone strip. The interface layer may comprise a plurality of pads and the touch conductive layer comprising a plurality of capacitive sensors, each of the sensors being aligned with at least one of the pads.

In a further aspect of the invention, a computer-implemented method of altering synthetized sound of a tactile feedback interface is provided. The method comprises the tactile feedback interface providing discrete capacitance measurements at a predetermined frequency, calculating and storing an average of the capacitance measurements to mitigate effects of background noise, detecting swiping and tapping motions on the tactile feedback interface by comparing the capacitance measurements to the calculated average over a time period comprising a plurality of cycles of the predetermined frequency, using the provided capacitance measurements to calculate a data model of position and direction of movement on the tactile feedback interface and altering the synthetized sound based on the calculated data model.

The predetermined frequency may be 256 discrete capacitance measurements per millisecond.

The tactile feedback interface may comprise a plurality of pads. As such, the method may further comprise providing the capacitance discrete capacitance measurements for each of the pads, calculating and storing the average of the capacitance measurements for each of the pads and comparing the capacitance measurements to the calculated average for each of the pads.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a perspective view of an embodiment of a partial timbre sound synthesis instrument comprising a swiping area and selector pads in accordance with the principles of the present invention.

FIG. 2 is an exploded view of an embodiment of a swiping tactile area of the sound synthesis instrument of FIG. 1.

FIG. 3 is an exploded view of an embodiment of selector pads in of the sound synthesis instrument of FIG. 1.

FIG. 4 is a detailed view of embodiments of conductive layers in accordance with the principles of the present invention.

### DETAILED DESCRIPTION OF THE INVENTION

A novel system and method for controlling sound synthesis instrument using tactile surface will be described hereinafter. Although the invention is described in terms of specific illustrative embodiments, it is to be understood that the embodiments described herein are by way of example only and that the scope of the invention is not intended to be limited thereby.

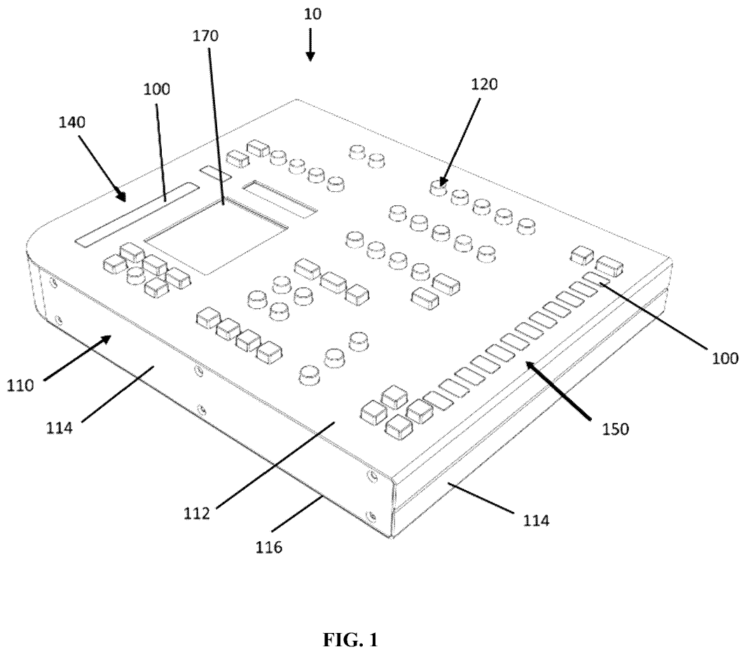

One skilled in the art shall understand that the measurements presented on the FIGS. 1-3 are exemplary dimensions of the present embodiment. Understandably, any other dimensions may be used within the scope of the present invention.

Referring to FIG. 1, an embodiment of a sound synthesis instrument 10 (also referred as an electronic musical instrument or synthesizer) comprising one or more tactile surfaces 100 is illustrated. The synthesizer 10 generally comprises a casing 110 comprising top 112, bottom 116 and side surfaces 114. In the illustrated embodiment, the top surface 112 comprises a plurality of controls 120 connected to a processing device (not shown), such as a controller or a computerized device. The controls 120 may comprise, but are not limited to, buttons 160, screens 170 and tactile or touch areas 100. The screens 170 may be any screen types or monitor known in the art showing relevant information for a synthesizer. The buttons 160 may be any buttons or controls known in the art of synthesizers.

The touch areas 100 may comprise a swiper or swiping area 140. In some embodiments, the swiper 140 comprises a plurality of layers forming a solid surface. The solid surface is typically coated and may be made of silicone. The coating 143 or 153, typically polyepoxide, when applied, forms a thin convex layer. The said thin convex layer is the touch surface where the user interacts with the synthesizer by touching or swiping with one or more digits (i.e., fingers or thumb) or other applicable parts of the body of the user. Preferably, the coating provides a modicum of friction so that the user has tactile feedback, but not too much friction, so fast swiping motions are possible. Furthermore, the coating preferably provides protection against ultraviolet and other forms of degradation as well as abrasion resistance.

The touch areas 100 may further comprise one or more selector pads 150 or a selecting area. In some embodiment, the selector pads 150 comprise a plurality of layers forming a solid surface. The solid surface is typically coated and may be made of coated silicone. The coating, typically polyepoxide, when applied, forms a thin convex layer. The said thin convex layer is the touch surface where the user interacts with the synthesizer by touching or swiping over more than one pad at a time with one or more digits or other applicable parts of the body of the user. Preferably, the coating provides a modicum of friction so that the user has tactile feedback, but not too much friction, so fast selection or swiping motions are possible across many consecutive pads. Furthermore, the coating preferably provides protection against ultraviolet and other forms of degradation as well as abrasion resistance. Understandably, any numbers of selector pads 150 in a selecting area may be used within the scope of the present invention. Also, in yet other embodiments, the pads 150 may be positioned differently relative to one another. The location and number of each of the components of the top surface of the synthesizer may further vary in other embodiments, for example, there may be more than one selector pads or more than one swiping area.

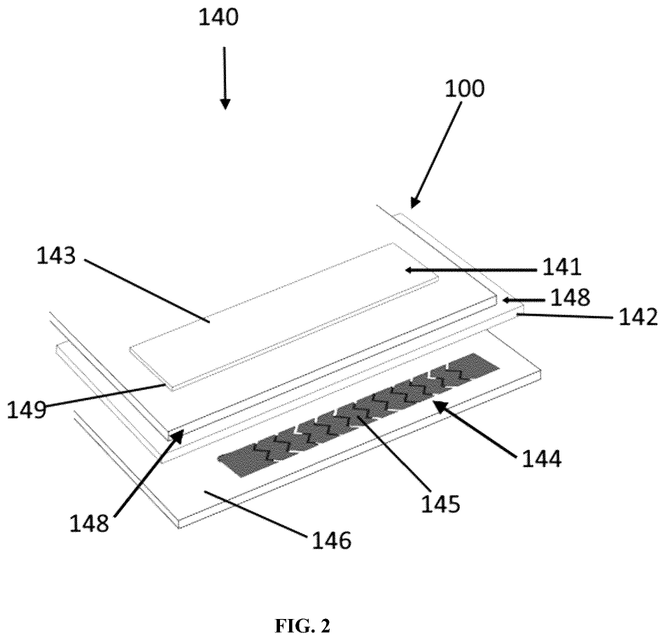

Referring now to FIG. 2, layers of an embodiment of a swiping area 140 are illustrated. In such embodiments, the swiping area 140 may be used to detect motion of digits or other body parts of the user along a single axis of movement. The swiper generally comprises a plurality of layers, such as an upper or interface layer 141, a conductive layer 144 and a structural layer 148, covering a printed circuit board 146.

The upper or interface layer 141 is a swiping layer made of a low-friction coating 143, such as but not limited to polyepoxide coating. The interface layer 141 typically comprises a layer of resilient yet hard material 142, such as silicon, covered with a coating layer 143.

The conductive layer 144 generally conducts or transfers the capacitance from presence of digits or other body parts of a user from the upper layer (i.e., top surface of the coating) to the printed circuit board 146. This interface layer 141 generally extends or protrudes from structural layer 148 through an aperture 149 in the structural layer 148. The interface layer 141 may comprise a single silicone strip 142.

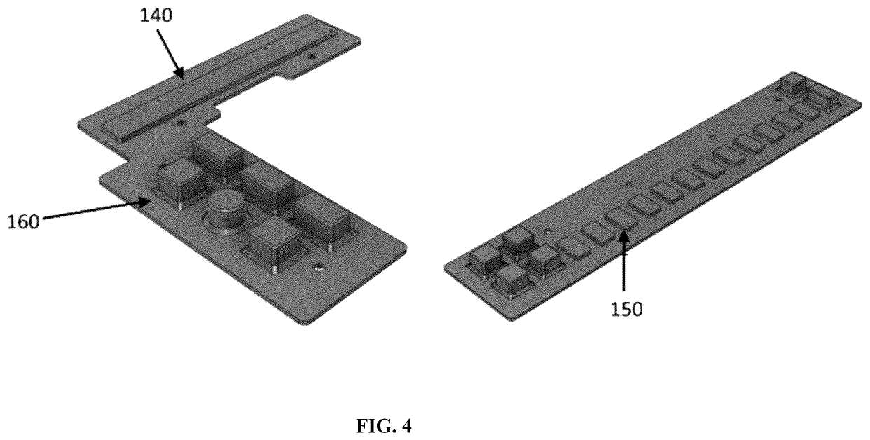

Referring to FIG. 4, embodiments of upper or interface layers 141 or 151 for the swiper 140 and the selecting pad areas 150 are shown. It may be appreciated that the swiper 140 and/or selecting pads 150 and/or buttons 160 may comprise a silicone layer 142 or 152. The swiper 140 and selector pads 150 may have a height allowing them to be substantially flush with the top surface of the metal casework 110 or structural layer 148. In other embodiments, a silicone layer 142 may only comprise the swiper 140, the selector pads 150 and/or buttons 160. Understandably, there may be one or more silicone layers 142 for a given synthesizer and the shape of the silicone layers 142 may therefore vary.

In this embodiment, the structural layer 148, also referred as casework 110, is embodied as sheet metal. In some embodiments, the sheet metal has a thickness of about 1.6256 mm. The structural layer 148 may be made of any other rigid material maintaining the structure of the swiping area 140.

The printed circuit board 146, or other method used to sense and capture capacitance data is underneath the other layers. The printed circuit board 146 generally comprises capacitive touch sensor pads 145. The layers of the swiper 140 thus provide tactile feedback to the musician aiming at facilitating and improving the musical's ability of one to precisely and accurately control the character of the sound that is generated by the instrument. The printed circuit board146, or other capacitive sense circuitry, generally comprises a means for the instrument to record and measure the operator's input.

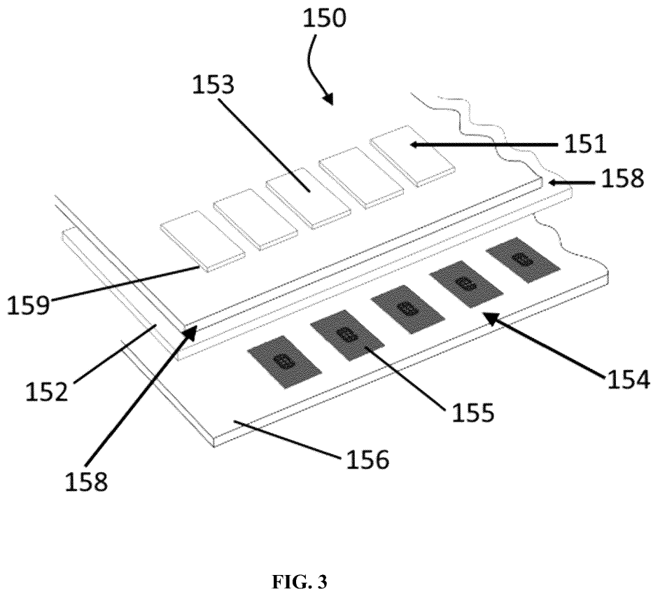

Referring now to FIG. 3, a cut-away view to show layers showing five (5) exemplary selector pads 150 is illustrated. In such embodiments, the selector pads 150 may provide discrete touch points for the musician to quickly and accurately select one or more partials. In such embodiments, the selector pad 150 comprises a plurality of layers. In the illustrated embodiment, a first swiping layer made of a low-friction coating 153, such as but not limited to polyepoxide coating.

The selector pad 150 further comprises a conductive layer 154 that conducts or transfers the capacitance from presence of a digits or other body parts of a user or operator from the top or interface layer 151 to the capacitance sensor 155 attached to the printed circuit board 156. The interface layer 151 is typically made of a silicone membrane or any other layer or rigid material 152 that conducts capacitance from digits of a user. The interface layer 151 generally extends or protrudes from the structural layer 158 through apertures 159 of the said structural layer. The interface layer 151 may comprise a single silicone strip 152 protruding at specific locations of the structural layer 158. The conductive layer 154, and therefore the upper layer 151, may have dimensions of about 14 mm length and about 8 mm width. Understandably, the selector pads 150 may have other shapes and dimensions. Additionally, more than one capacitive touch sensor 155 may be located under a single upper layer silicone pad 150.

The selector pad 150 may further comprise a structural layer 158, also referred to as casework 110. In this embodiment, the structural layer 158 is made of sheet metal. In some embodiments, the sheet metal has a thickness of about 1.6256 mm.

The printed circuit board 156 of the selector pad 150 generally comprises capacitive touch sensors 155 having dimension similar to the pads 150. Accordingly, a user tapping on the polyepoxide pads of the upper layer 151 may also activate the capacitive touch sensor pads 155 on the printed circuit board 156.

The printed circuit board 146 or 156 comprising sensors 145 or 155, or other method used to sense and capture capacitance data is underneath the other layers. The capacitive sensing circuitry under the touch pads provides means for the instrument to record and measure the musicians input within the touch areas.

Referring back to FIG. 1, the illustrated embodiment of the synthesizer's embodiment may be desirable compared to synthesizer of the prior art for the at least some of the following reasons: the size, shape and spacing of the tactile touch areas being ergonomic; the friction of the touch areas providing a very desirable “feel” to the tactile surface; and the functionality of the touch areas as they specifically relate to the implementation of a partial timbre sound synthesis instrument. It may be appreciated that even though polyepoxide is the embodied coating used on the touch areas, other polymeric coatings have similar properties may also be used in other embodiments.

Electronic circuitry is provided to communicate the recorded capacitive touch information from the touch area circuitry to the note specification system (see for instance, item 251, FIG. 1B of U.S. Pat. No. 4,554,855).

In some embodiments, the capacitive touch sensor apparatus 10 provides 256 discrete capacitance measurements to the computer every millisecond. The computer, controller or computerized device averages 256 measurements to mitigate the effects of background noise. The computer records the average reading for each millisecond for each measurement pad. By observing the change in capacitance of each pad over a time period of several hundred milliseconds the computer can detect swiping and tapping motions of the operating musicians' digits. The parameter values the operating musician wishes to alter may be increased or decreased as a function of the length of the swipe. In events of tapping, the parameter value can be increased or decreased by a fixed nudge amount. In another example, if one finger or thumb is held on the unit while a second digit swipes, the computer engages fine mode and the parameter can be adjusted by smaller increments. Understandably, the apparatus 10 may provide more or less than 256 capacitance measurements and may capture such capacitance at any predetermined intervals.

A method to alter synthetized sound, the method comprising capturing capacitance values of a body portion in contact with a touch pad at a predetermined frequency, using the captured capacitances to create a data model of position and direction of movement of the body portion and altering the synthetized sound based on the data model.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A partial timbre sound synthesis instrument comprising:
a structural layer;
a tactile feedback interface; and
a processing device in data communication with the tactile feedback interface, the processing device being configured to build a model from the data signals received from the tactile feedback interface.

2) The instrument of claim 1, the tactile feedback interface comprising at least one swiper.

3) The instrument of claim 1, the tactile feedback interface comprising at least one selector pad.

4) The instrument of claim 1, the tactile feedback interface comprising:
a touch conductive layer;
an interface layer over the conductive layer;
wherein the structural layer comprises apertures allowing passage of one or more portions of the interface layer.

5) The instrument of claim 4, wherein the interface layer extends or protrudes from the apertures of the structural layer.

6) The instrument of claim 4, the structural layer being made of a rigid material.

7) The instrument of claim 4, the interface layer comprising a plurality of pads and the touch conductive layer comprising a plurality of capacitive sensors, each of the sensors being aligned with at least one of the pads.

8) The instrument of claim 4, the touch conductive layer comprising a printed circuit board comprising a capacitive sensor.

9) The instrument of claim 8, the printed circuit board further comprising a musical instrument recorder and input measurement mechanism.

10) The instrument of claim 4, the interface layer being made of a non-conductive and resilient material.

11) The instrument of claim 10, the interface layer being made of silicone.

12) The instrument of claim 11, the silicone layer being coated.

13) The instrument of claim 12, the coating being polyepoxide.

14) The instrument of claim 12, the coating being made of material providing a modicum of friction, the coating allowing fast swiping motions from a user while receiving tactile feedback.

15) The instrument of claim 12, the coating being made of material providing protection against ultraviolet degradation and other forms of degradation.

16) The instrument of claim 10, the interface layer forming a thin convex layer.

17) The instrument of claim 10, the interface layer comprising a single silicone strip.

18) A computer-implemented method of altering synthetized sound of a tactile feedback interface, the method comprising:
the tactile feedback interface providing discrete capacitance measurements at a predetermined frequency;
calculating and storing an average of the capacitance measurements to mitigate effects of background noise;
detecting swiping and tapping motions on the tactile feedback interface by comparing the capacitance measurements to the calculated average over a time period comprising a plurality of cycles of the predetermined frequency;
using the provided capacitance measurements to calculate a data model of position and direction of movement on the tactile feedback interface; and
altering the synthetized sound based on the calculated data model.

19) The computer-implemented method of claim 18, the predetermined frequency being 256 discrete capacitance measurements per millisecond.

20) The computer-implemented method of claim 18, the tactile feedback interface comprising a plurality of pads, the method further comprising:
providing the capacitance discrete capacitance measurements for each of the pads;
calculating and storing the average of the capacitance measurements for each of the pads; and
comparing the capacitance measurements to the calculated average for each of the pads.
